(19) United States
(12) Patent Application Publication
(10) Pub. No.: US 2025/0276404 A1
(43) Pub. Date: Sep. 4, 2025

(54) SYSTEM AND METHOD FOR WELD SEAM TRACKING

(71) Applicant: Magna International Inc., Aurora (CA)

(72) Inventors: Georg PETRIN, Kottingbrunn (AT); Dominik BERTALAN, Dreistetten (AT)

(21) Appl. No.: 19/066,749

(22) Filed: Feb. 28, 2025

Related U.S. Application Data
(60) Provisional application No. 63/560,236, filed on Mar. 1, 2024.

(51) Int. Cl. B23K 26/03

(52) U.S. Cl. CPC B23K 26/032

(57) ABSTRACT

A system and method tracking location of a seam between metal parts before, during and/or after a process of joining the parts together is provided. The parts are typically formed of steel or aluminum and designed for use in a vehicle. The parts are typically joined together by welding, such as gas metal arc welding. A cell contains the parts to be joined, and a measuring device is mounted on a wall of the cell for detecting the location of a seam between the parts. The system further includes a software algorithm and a controller for determining a joining path, controlling and/or adjusting the joining process based on the location of the seam detected by the measuring device. The measuring device can detect other features, such as presence of a gap between the parts, height of the parts, and location of the weld seam after the joining process.

### CROSS-REFERENCE TO RELATED APPLICATIONS

This U.S. Non-Provisional Patent application claims the benefit of and priority to U.S. Provisional Patent Application Ser. No. 63/560,236, filed Mar. 1, 2024, titled “System and Method for Weld Seam Tracking,” the entire disclosure of which is hereby incorporated by reference in its entirety.

### BACKGROUND OF THE INVENTION

### 1. Field of the Invention

The invention relates generally to a system and method for tracking location of a seam between two or more parts during a process of joining the parts together, for example two steel parts joined by gas metal arc welding.

### 2. Related Art

Welding is one technique often use to form components from multiple parts. For example, gas metal arc welding, can be used to join two metal parts, such as steel or aluminum, together to provide a component for use in a vehicle.

One challenge faced during the welding process is the presence of defects due to lack of suitable systems and methods for tracking the location of a seam between the two parts being joined together. The defects could lead to compromised weld quality, which could require reworking of the weld or scrapping of the parts. The defects could also lead to potential safety concerns associated with using the components with the compromised weld quality. It is desirable to implement an effective weld seam tracking system and method to address these problems and overcome the challenges associate with welding.

### SUMMARY

One aspect of the disclosure provides a system for determining location of a seam between parts. The system includes at least one robot for controlling and adjusting movement of at least one joining tool for joining parts together; and a measuring device spaced from the at least one robot and the at least one joining tool for determining location of a seam between the parts before, during, and/or after the joining step.

Another aspect of the disclosure provides a method for determining location of a seam between parts. The method includes joining parts together along at least one seam between the parts using at least one robot controlling and adjusting movement of at least one joining tool; and determining a location of the at least one seam located between parts before, during, and/or after the joining step using a measuring device. The measuring device is spaced from the at least one robot and the at least one joining tool.

### BRIEF DESCRIPTION OF THE DRAWINGS

Other advantages of the present invention will be readily appreciated, as the same becomes better understood by reference to the following detailed description when considered in connection with the accompanying drawings wherein:

FIG. 1 illustrates a system for tracking location of a seam between two parts during a process of welding the two parts together according to an example embodiment;

FIG. 2 illustrates two parts and a camera for detecting location of a seam between the two parts according to an example embodiment; and

FIG. 3 illustrates a method for determining location of a seam between two parts before, during and/or after a process of welding the two parts together according to an example embodiment.

### DESCRIPTION OF EXAMPLE EMBODIMENTS

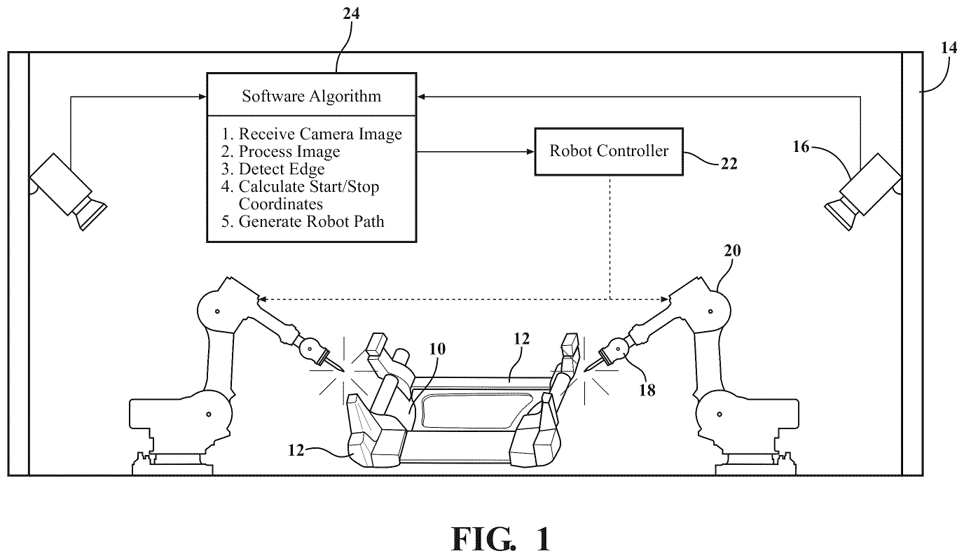

One aspect of the disclosure provides a system and method for tracking location of a seam 10 between two or more parts 12 before, during and/or after a process of joining the two parts 12 together. The system and method is independent of any robot, welding gun, welding torch, or other piece of equipment used to join or perform a process on the parts 12. The system and method can also include quality of a weld located along the seam 10 between the parts 12. An example of the system is shown in FIG. 1.

As shown in FIG. 1, the system includes a cell 14 for containing the parts 12 to be joined. Typically, the parts 12 are disposed within a welding fixture, but they can be located on other equipment. The cell 14 has multiple walls that surround an enclosed space. Two or more parts 12 are disposed in the cell 14 for joining. The parts 12 are typically formed of metal, such as steel, aluminum, or an aluminum alloy. The shape of the parts 12 is typically designed for use in a vehicle application. The process of joining the parts 12 together typically includes welding, such as gas metal arc welding, laser welding, or laser brazing operations. However, the joining process can include other techniques, such as by an adhesive.

The system further includes at least one measuring device 16 for detecting the location of the seam 10 between the two parts 12 during and/or after a process of joining the parts 12 together. The measuring device 16 can be any device capable of detecting the location of the seam 10, such as a camera, laser, or scanner. According to one example embodiment, the measuring device 16 is a camera with a 75 mm objective and red spotlight. This type of camera is able to detect edges and thus is feasible for seam tracking, can detect multiple positions in a single image, and includes multiple points output for curve tracking. According to another example embodiment, the measuring device 16 includes a camera and laser. In this case, the measuring device 16 is able to generate three-dimensional images (x-axis, y-axis, z-axis) and includes a detection window from 2000 mm with an accuracy of +0.4 mm (1260×1260×1000 mm). This measuring device 16 is also able to detect multiple positions in a single image. According to another example embodiment, the measuring device 16 is a 2D or 3D line scanner.

In the example of FIG. 1, the measuring device 16 of the system includes two cameras disposed on opposite sides of the parts 12 being joined. The system could include additional measuring devices 16 if needed to view all edges of the parts 12. The measuring device 16 is typically mounted on a wall of the cell 14 at a location that allows the measuring device 16 to view the seam 10 between the parts 12 being joined. Alternatively, the measuring device 16 could be disposed on a separate stand inside of the cell 14.

The example system of FIG. 1 also includes at least one welding gun 18 for joining the parts 12 together. According to the example embodiment, the welding gun 18 performs a gas metal arc welding process on the parts 12. During the welding process, an electric arc forms between a consumable wire electrode and the metal parts 12, which heats the parts 12 and causes them to melt and join together. A shielding gas is also fed through the welding gun 18, which shields the process from atmospheric contamination. However, other equipment can be used to join the parts 12 together or process the parts 12. In the case of laser welding or joining by adhesive, for example, no welding guns are needed but other tools are used in place of the welding gun 18. Each welding gun 18, or other tool, is typically connected to a robot 20, and the robot 20 controls the movement of the welding gun 18

The system further includes a controller 22 in communication with the measuring device 16, the robot 20, and/or the welding gun 18. The controller 22 is typically connected to the robot 20 which controls movement of the welding gun 18. According to the example embodiment, the controller 22 includes a software algorithm 24, or is in communication with the software algorithm 24, which is capable of carrying out the method. The system can also include multiple robots 20 controlled by the same or different controllers 22 and software algorithm 24.

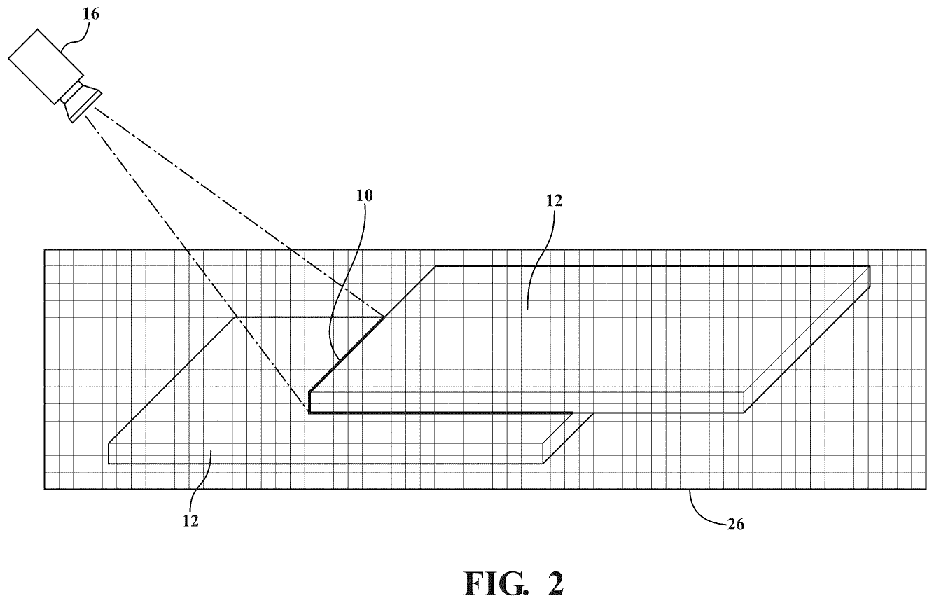

The method typically includes determining a preferred path for the seam 10 between the two parts 12, for example the desired location of the weld. In this case, the method includes placing the parts 12 to be joined in the cell 14 and using the measuring device 16 to obtain one or more images of the two parts 12, particularly in the area of the seam 10. The images are processed and used by the software algorithm 24 to determine the location of the edges and/or height of the parts 12. FIG. 2 illustrates a laser grid 26 used to determine the edge locations, seam 10, and heights of the parts 12. The laser grid 26 is not always needed as it depends on the reflectivity and contrast of the parts 12 to be welded. The software algorithm 24 then calculates desired start and end coordinates or otherwise determines a desired location of a weld along the seam 10 between the parts 12, and generates a path for the robot 20 to follow during the welding process in order to obtain the desired location of the welded seam 10.

The method can also include obtaining images of the welded seam 10 throughout the joining process, and using the controller 22 to adjust the path of the robot 20, and thus the location of the welded seam 10, when the seam 10 deviates from the desired path. The controller 22 could also adjust other welding parameters to achieve the desired process, such as wire feed speed, energy, stick out, torch angle, and/or temperature. The system may be designed to track the location of the unwelded or welded seam 10 in real time throughout the joining process. At the end of the process, the measuring device 16 can obtain images of the finished welded seam 10 to confirm that the welded seam 10 is in an acceptable location.

Due to the placement of the measuring device 16, the system is able to obtain images and adjust the paths of all robots 20 at once. This is an advantage over comparative systems which include a camera mounted on one of the robots, in which case the images obtained at any given time include only the path of the one robot. In addition, due to the placement of the measuring device 16, if the parts 12 include multiple seams 10, the location of all seams 10 between the parts 12 can be determined at the same time. If one measuring device 16 is located directly above the seam 10 and can only provide an image showing two dimensions (x-axis, y-axis), then an additional measuring device 16 located at the side of the seam 10 may be needed to provide an image showing the third dimension (z-axis).

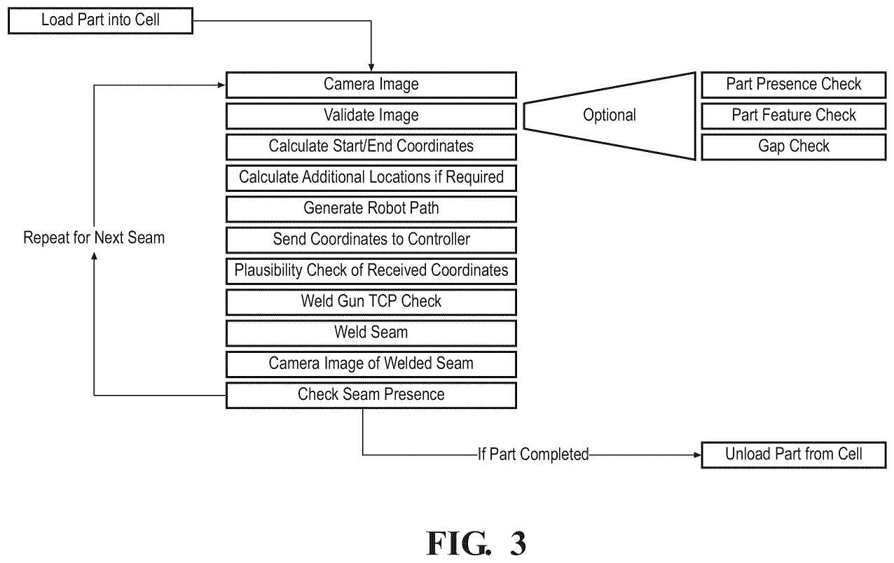

In addition to the steps discussed above, which typically include generating location information about the seam 10 and the parts 12 to be welded to generate a desired path, sending the location of the seam 10 and the parts 12 and optionally a deviation from the expected locations to the robot 20 before and during the welding step, and directing all robots 20 to weld according to the generated path, the method can include other steps. For example, the method can be applied to other applications which involve the use of a robot 20, for example other joining, handling, or grinding methods. The method could incorporate an automated check for presence of the parts 12 and/or additional features, such as weld nuts, bolts, or holes, present in the part 12, before, during, and/or after welding. The method could also check to see if a weld seam 10 has been previously generated, measure gaps between the parts 12 before welding, measure the location of the parts 12 before and after welding, and measure any distortion of the parts 12 after welding. The method can also include checking the plausibility of the desired weld path and location of the welding gun 18. The method is typically repeated multiple times in order to weld multiple parts 12. A method according to another example embodiment with additional optional steps is shown in FIG. 3.

As indicated above, the system and method described herein provides numerous advantages. First, the system is a robot-independent seam tracking system that can be mounted at the cell level, eliminating limitations associated with traditional tracking systems mounted on individual robots. Since the system is robot-independent, it is not highly dependent on welding direction or limited to the specific piece of equipment they are mounted on. There is no limitation in welding direction. The system and method can also improve weld quality and reduces welding defects by accurately tracking and adjusting the welding path on the actual edges of the parts 12, ensuring precise and consistent welded seams 10 and thus less scrap. The robot-independent system and method disclosed herein offers greater flexibility and eliminates the need for multiple tracking devices 16. It is capable of tracking edges of parts 12 in various different welding scenarios. The system is also highly accurate and efficient.

Obviously, many modifications and variations of the present invention are possible in light of the above teachings and may be practiced otherwise than as specifically described while within the scope of the following claims.

1. A system for determining location of a seam between parts, comprising:
at least one robot for controlling and adjusting movement of at least one joining tool for joining parts together; and
a measuring device spaced from the at least one robot and the at least one joining tool for determining location of a seam between the parts before, during, and/or after the joining step.

2. The system of claim 1 including a controller in communication with the measuring device and the at least one robot for controlling and/or adjusting the movement of the at least one robot based on the location of the seam determined by the measuring device.

3. The system of claim 2, wherein the controller is in communication with a software algorithm.

4. The system of claim 1 including a cell for containing the parts, the at least one robot, the at least one joining tool, and the measuring device.

5. The system of claim 4, wherein the measuring device is mounted on a wall of the cell or disposed on a stand in the cell.

6. The system of claim 1, wherein the joining tool is a welding gun for welding the parts together.

7. The system of claim 1, wherein the measuring device includes a camera.

8. The system of claim 1 including a cell for containing the parts, the at least one robot, the at least one joining tool, and the measuring device;
the measuring device being disposed in the cell or mounted on a wall of the cell;
the parts being disposed on a welding fixture in the cell;
the parts being formed of metal;
the at least one joining tool including a welding gun for welding the parts together; and
the measuring device including a camera.

9. The system of claim 1, wherein the system includes a plurality of the robots and a plurality of the joining tools, and wherein each robot controls one of the joining tools.

10. A method for determining location of a seam between parts, comprising:
joining parts together along at least one seam between the parts using at least one robot controlling and adjusting movement of at least one joining tool;
determining a location of the at least one seam located between parts before, during, and/or after the joining step using a measuring device, wherein the measuring device is spaced from the at least one robot and the at least one joining tool.

11. The method of claim 10 including controlling and/or adjusting the movement of the at least one robot based on the location of the at least one seam determined by the measuring device.

12. The method of claim 10, wherein the measuring device is mounted on a wall of the cell or disposed on a stand in the cell.

13. The method of claim 10, wherein the measuring device includes a camera, and the method further includes obtaining images of the parts using the camera to determine the location of the at least one seam before, during, and/or after the joining step.

14. The method of claim 10, wherein the joining step includes welding the parts together.

15. The method of claim 10 including a plurality of the seams located between the parts, and the method further includes determining the locations of all of the seams between the parts using the measuring device.

16. The method of claim 15, wherein the at least one robot includes a plurality of the robots, the at least one joining tool includes a plurality of the joining tools, and the method further includes controlling and/or adjusting the movement of the robots and joining tools based on the location of the seams determined by the measuring device.

17. The method of claim 10 including determining a desired path of the at least one robot to follow during the joining step based on the location of the at least one seam determined by the measuring device prior to the joining step.

18. The method of claim 17 including controlling and/or adjusting the path of the at least one robot during the joining step based on the desired path.

19. The method of claim 10 including determining the location of each seam of the at least one seam located between the parts before, during, and after the joining step using the measuring device, and wherein the measuring device includes a single camera.

20. The method of claim 10 including determining a presence of features or holes in the parts before, during, and/or after the joining step using the measuring device.
